(19) United States
(12) Patent Application Publication
(10) Pub. No.: US 2007/0124129 A1
(43) Pub. Date: May 31, 2007

(54) Circuit evaluation method and circuit evaluation apparatus

(75) Inventors: Yasuo Ohtomo, Kawasaki (JP); Nobukazu Koizumi, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/356,184

(22) Filed: Feb. 17, 2006

(30) Foreign Application Priority Data
Nov. 30, 2005 (JP) 2005-346222

(51) Int. Cl. G06F 9/455

(52) U.S. Cl. 703/23

(57) ABSTRACT

The present invention provides a circuit evaluation method for evaluating a digital circuit which is mounted to, and operated in, a system apparatus, comprising: a first step for preparing first emulation logic which emulates an operation of the digital circuit; a second step for preparing second emulation logic which emulates an operation of an analog section through which passes a signal input to, and output from, the digital circuit in a state of being mounted to the system apparatus; and a third step for evaluating an operation of the digital circuit in a state of being mounted to the system apparatus by making the first and second emulation logic operate in a programmable logic circuit.

### BACKGROUND OF THE INVENTION

1. Field of the Invention

The present invention relates to a circuit evaluation technique, for example to a technique effectively applicable to an evaluation, et cetera, of a digital circuit for use in various apparatuses by coexisting with an analog circuit at an apparatus level prior to a shipment.

2. Description of the Related Art

In developing a system apparatus equipped with an LSI (large scale integrated circuit) for example, an evaluation at an apparatus level with an LSI actually being installed in the system apparatus is sometimes necessary prior to shipping the aforementioned LSI.

Although a block of a digital circuit to be replaced by an LSI may be evaluated by a software simulation in such a case, depending on how a test pattern is made, not all operations of functions can necessarily be confirmed by such a software simulation. With an increased circuit size of an LSI, validation of functions by a software simulation becomes proportionately difficult.

As for a block other than one being designed as an LSI, while an evaluation at the level of each block is possible, the part having an interface with the LSI, however, needs to be confirmed according to an actual usage, thus making it hard to perform an apparatus level evaluation prior to a shipment of the LSI.

Meanwhile, an analog circuit requires a validation at the same operation speed as a usage in an actual apparatus.

In an apparatus equipped with an LSI, although an apparatus level evaluation prior to the LSI shipment can be performed only at the level of each block by cutting out a block, an evaluation at the entire apparatus level is faced with technical problems such as the presence of an analog circuit, which requires an evaluation of a part interfacing with the LSI and a validation at the actual operation speed, thus precluding an evaluation unless the LSI is installed in the apparatus.

A patent document 1 has disclosed a simulation method for converting an S function display transfer function of an analog part to a Z function by a sampling cycle having a cycle corresponding to a simulation accuracy.

That is, what is disclosed is a technique for structuring a digital circuit network corresponding to the aforementioned Z function from the converted Z function by using an adder, multiplier and delay circuit and performing a simulation of a mixed signal circuit by combining the aforementioned digital circuit network with the remaining digital circuit part (other than the analog circuit part) as input to a logic simulator.

The patent document 1, however, deals only with a mixed signal circuit and accordingly it is difficult to apply to an analog part rather than a digital circuit, for example to such an apparatus configuration as to include a wireless propagation section of a signal.

A patent document 2 has disclosed an electronic circuit apparatus, comprising a microcomputer, a random access memory (RAM), a variable logic circuit and a rewritable nonvolatile memory, all on a high density board, for simulating functions to be implemented mainly by software by furnishing the variable logic circuit with desired logic functions.

The electronic circuit according to the patent document 2 does not disclose a concrete evaluation technique relating to a mixed signal circuit.

[Patent document 1] laid-open Japanese patent application publication No. 04-74272

[Patent document 2] WO publication 2002/057921 (International disclosure date: Jul. 25, 2002)

### SUMMARY OF THE INVENTION

A purpose of the present invention is to provide a technique for enabling an evaluation of a digital circuit in a state of being installed in a system apparatus prior to shipping the aforementioned digital circuit which is mounted to the aforementioned system apparatus including an analog part.

Another purpose of the present invention is to provide a technique for enabling a validation of functions of a digital circuit which has been difficult to evaluate by a software simulation and an advance validation of failure which has conventionally been discovered by actually mounting an apparatus after shipping a digital circuit.

Yet another purpose of the present invention is to provide a technique for enabling a reduction of a development period and production cost of a digital circuit which is mounted to a system apparatus by including an analog part.

A further purpose of the present invention is to provide a technique for enabling an evaluation of a digital circuit in a state of being installed in a system apparatus, prior to shipping the aforementioned digital circuit, independent of an actual operating frequency of an analog part, in the digital circuit which is mounted to the aforementioned system apparatus by including an analog part.

A first aspect of the present invention is to provide a circuit evaluation method for evaluating a digital circuit which is mounted to, and operated in, a system apparatus, comprising: a first step for preparing first emulation logic which emulates an operation of the digital circuit; a second step for preparing second emulation logic which emulates an operation of an analog section through which passes a signal input to, and output from, the digital circuit in a state of being mounted to the system apparatus; and a third step for evaluating an operation of the digital circuit in a state of being mounted to the system apparatus by making the first and second emulation logic operate in a programmable logic circuit.

A second aspect of the present invention is to provide the circuit evaluation method according to the first aspect, wherein the system apparatus is a telecommunication apparatus for communicating with the system apparatus on an opposite side, and the second emulation logic implements, in the programmable logic circuit, an operation of the analog section through which passes the signal exchanged between the digital circuits respectively mounted to each of a pair of the system apparatuses.

A third aspect of the present invention is to provide the circuit evaluation method according to the first aspect, wherein the analog section includes a wireless propagation section of the signal, the second emulation logic includes third emulation logic for emulating an operation of the wireless propagation section, and the third step is for making a telecommunication state of the signal in the wireless propagation section implemented in the programmable logic circuit by the third emulation logic change in various ways by variably setting an operating parameter of the third emulation logic externally and for evaluating the digital circuit in a state of being mounted to the system apparatus.

A fourth aspect of the present invention is to provide the circuit evaluation method according to the first aspect, wherein the programmable logic circuit is a field-programmable gate array (FPGA).

A fifth aspect of the present invention is to provide the circuit evaluation method according to the first aspect, wherein the system apparatus is a wireless telecommunication apparatus and the digital circuit is a base band processing circuit.

A sixth aspect of the present invention is to provide a circuit evaluation apparatus for evaluating a digital circuit which is mounted to, and operated in, a system apparatus, comprising: a programmable logic circuit for mounting first emulation logic which emulates an operation of the digital circuit and second emulation logic which emulates an operation of an analog section through which passes a signal input to, and output from, the digital circuit in a state of being mounted to the system apparatus; and a control unit for emulating an operation of the digital circuit in a state of being mounted to the system apparatus by controlling the programmable logic circuit to make the first and second emulation logic operate.

A seventh aspect of the present invention is to provide the circuit evaluation apparatus according to the sixth aspect, wherein the system apparatus is a telecommunication apparatus for communicating with the system apparatus on an opposite side, and the second emulation logic implements, in the programmable logic circuit, an operation of the analog section through which passes the signal exchanged between the digital circuits respectively mounted to each of a pair of the system apparatuses.

An eighth aspect of the present invention is to provide the circuit evaluation apparatus according to the sixth aspect, wherein the analog section includes a wireless propagation section of the signal, and the circuit evaluation apparatus further comprises third emulation logic for implementing an operation of the wireless propagation section in the programmable logic circuit, and a wireless propagation section control unit for the purpose of making a telecommunication state of the signal in the wireless propagation section variously change by variably setting an operating condition of the third emulation logic externally.

A ninth aspect of the present invention is to provide the circuit evaluation apparatus according to the sixth aspect, wherein the programmable logic circuit comprises a field-programmable gate array (FPGA).

A tenth aspect of the present invention is to provide the circuit evaluation apparatus according to the sixth aspect, wherein the system apparatus is a wireless telecommunication apparatus and the digital circuit is a base band processing circuit.

That is, in a digital circuit such as an LSI to be mounted to a system apparatus for example, the present invention is comprised to simulate a block part of a digital circuit, which is designed as a product, and an analog section part from an interface of the aforementioned digital circuit to that of a digital circuit existing in a system apparatus on the opposite side by digitalizing by using a programmable logic circuit, e.g., an FPGA, that can be implemented earlier than a product production of the digital circuit, for evaluating a product at an apparatus level prior to shipping it.

This enables an evaluation of a digital circuit at an apparatus level prior to shipping the aforementioned digital circuit by implementing the same operation state as the actual system apparatus where a digital circuit and an analog section coexist, by using only a digital circuit having no analog part.

This also enables an evaluation at an apparatus level in the same operating state as an apparatus as the subject of actual installation prior to producing a digital circuit and accordingly a validation of a function which has been conventionally difficult to evaluate by a software simulation.

This also enables a validation, prior to shipping, of a failure in a digital circuit which has conventionally been discovered during an evaluation process in an actual apparatus after shipping the aforementioned digital circuit, hence reducing the number of occurrence of remanufacturing a digital circuit, and accomplishing a shortening of a development period and a reduction of production cost.

This also eliminates a limitation of an evaluation only at an actual operating speed which is caused by the intervention of a digital section as a result of digitalizing both a digital circuit and an analog section between the aforementioned digital circuits, thus enabling a validation of operation at low speed. This further eliminates a necessity of using a high operating frequency rating, expensive components for constituting an evaluation apparatus for use in the validation of an operation, thereby enabling an evaluation of the digital circuit at low cost.

### BRIEF DESCRIPTION OF THE DRAWINGS

FIG. 1 is a conceptual diagram exemplifying a configuration of a circuit evaluation apparatus embodying a circuit evaluation method according to an embodiment of the present invention;

FIG. 2 is a conceptual diagram showing a modified example of a circuit evaluation apparatus according to an embodiment of the present invention;

FIG. 3 is a block diagram exemplifying a system apparatus comprising a digital circuit evaluated by a circuit evaluation apparatus according to an embodiment of the present invention;

FIG. 4 is a flow chart exemplifying an operation of a circuit evaluation method and apparatus according to an embodiment of the present invention; and

FIG. 5 is a process chart exemplifying a production method of a digital circuit to which is applied a circuit evaluation method according to an embodiment of the present invention.

### DESCRIPTION OF THE PREFERRED EMBODIMENTS

The following is a detailed description of the preferred embodiments of the present invention while referring to the accompanying drawings.

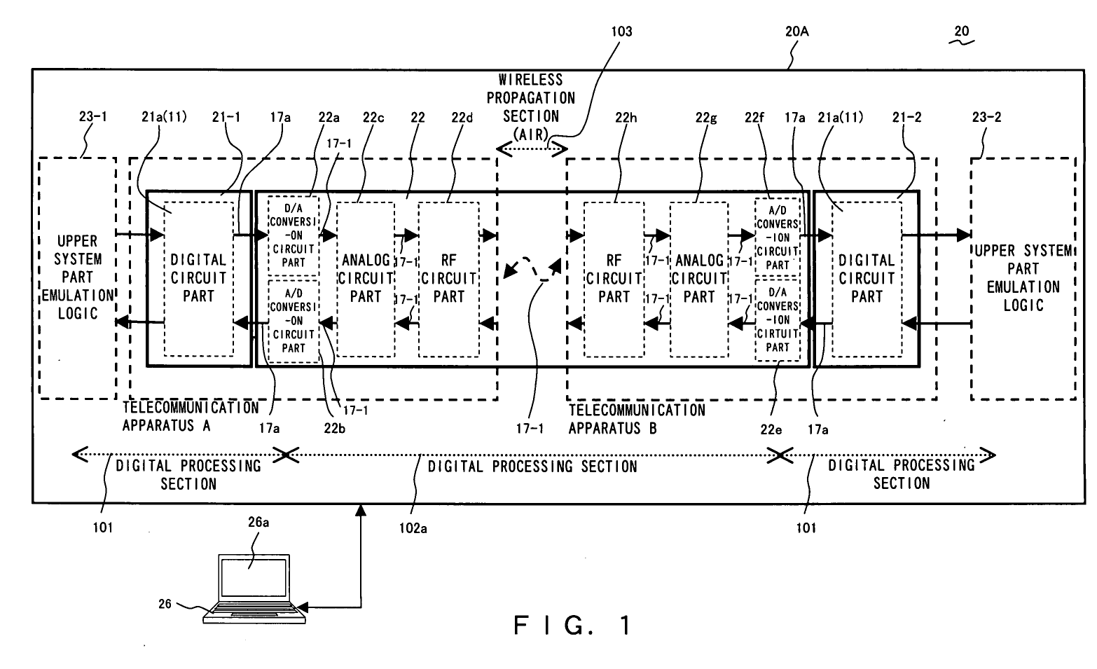

FIG. 1 is a conceptual diagram exemplifying a configuration of a circuit evaluation apparatus embodying a circuit evaluation method according to an embodiment of the present invention.

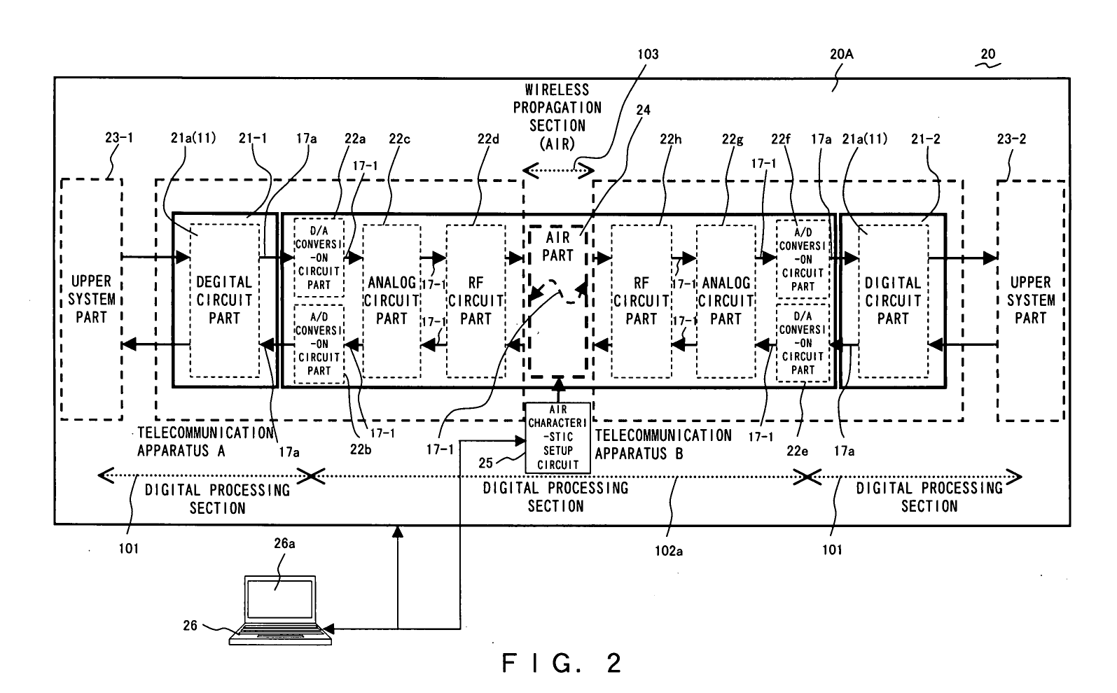

FIG. 2 is a conceptual diagram showing a modified example of a circuit evaluation apparatus according to the present embodiment.

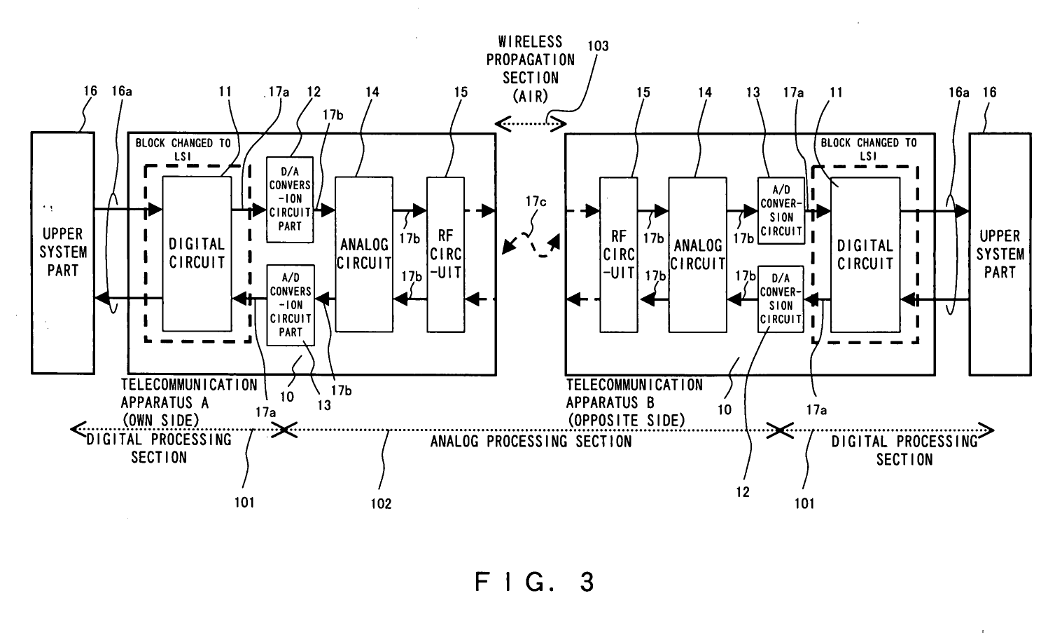

FIG. 3 is a block diagram exemplifying a system apparatus comprising a digital circuit evaluated by a circuit evaluation apparatus according to the present embodiment.

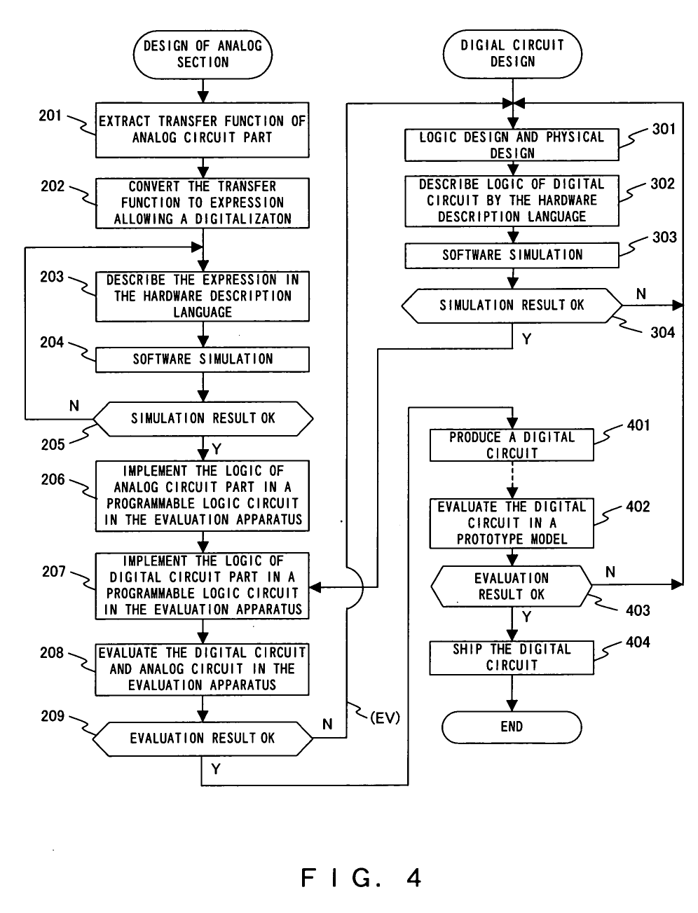

FIG. 4 is a flow chart exemplifying an operation of a circuit evaluation method and apparatus according to the present embodiment.

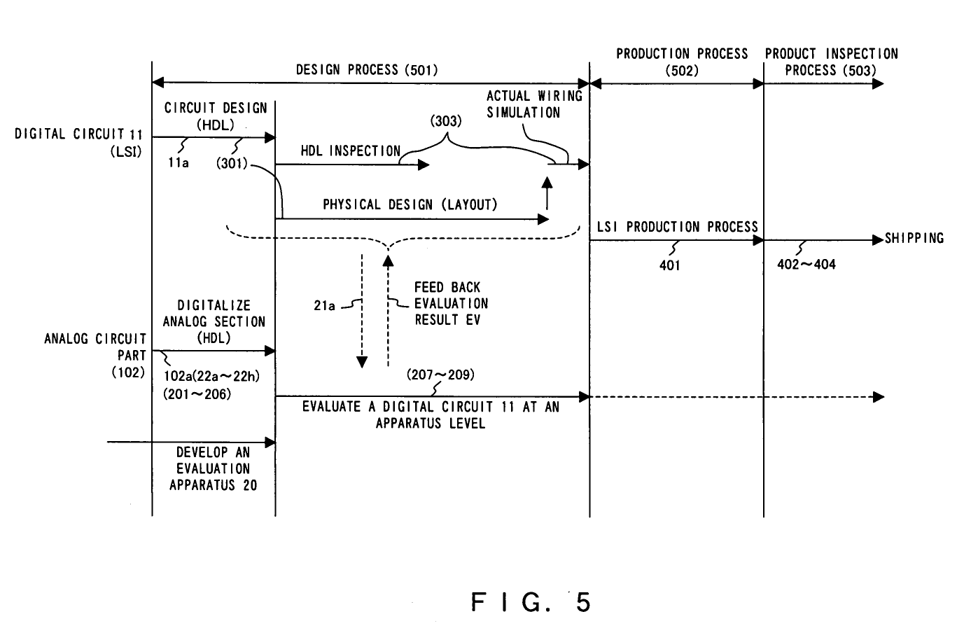

FIG. 5 is a process chart exemplifying a production method of a digital circuit to which is applied a circuit evaluation method according to the present embodiment.

The present embodiment is described in the case of being applied to a telecommunication apparatus as an example of a system apparatus.

The first description is of a configuration of a telecommunication apparatus 10 as the subject of evaluation by a circuit evaluation apparatus according to the present embodiment with reference to FIG. 3.

Note that FIG. 3 exemplifies the state of performing a mutual wireless telecommunication between a pair of telecommunication apparatuses 10 (i.e., telecommunication apparatuses A and B) which have the same configuration and that the following describes the configuration of one telecommunication apparatus A while a duplicate description of the corresponding part of the telecommunication apparatus B is omitted by assigning the same component numbers to corresponding components.

The telecommunication apparatus 10 according to the present embodiment includes a digital circuit 11, a D/A (digital to analog) conversion circuit 12, an A/D (analog to digital) conversion circuit 13, an analog circuit 14, an RF (radio frequency) circuit 15 and an upper level system 16.

The digital circuit 11 is a digital circuit, such as a base band LSI for example, for carrying out protocol processing for performing a telecommunication compliant to a prescribed telecommunication standard for example.

The D/A conversion circuit 12 converts a digital signal 17a output from the digital circuit 11 to an analog signal 17b.

The A/D conversion circuit 13 converts an analog signal 17b arriving from the analog circuit 14 to a digital signal 17a.

The analog circuit 14 for example amplifies an analog signal 17b exchanged with the outside by way of the RF circuit 15.

The RF circuit 15 carries out the processing of converting, and transmitting to the outside space, an analog signal 17b arriving from the analog circuit 14 into a high frequency signal 17c. And the RF circuit 15 carries out the processing of converting a high frequency signal 17c received from the external space into an analog signal 17b.

The upper level system 16 comprises for example a computer for controlling the digital circuit 11 by way of a digital control signal 16a.

As described above, the telecommunication apparatus 10 contains a digital processing section 101 from the upper level system 16 through to the digital circuit 11.

Meanwhile, there is an analog processing section 102 for dealing with an analog signal 17b in an analog state and a high frequency signal 17c from the D/A conversion circuit 12 (also the A/D conversion circuit 13) to the A/D conversion circuit 13 (also the D/A conversion circuit 12 of the telecommunication apparatus B on the opposite side.

And a part of the analog processing section 102 is a wireless propagation section 103 indicating a space in which a high frequency signal 17c is propagated.

In the case of producing the digital circuit 11 for use in the telecommunication apparatus 10, what is required is not only a testing of the unit of the digital circuit 11 itself, but also testing in a state of the digital circuit 11 being installed in the telecommunication apparatus 10, that is, at an apparatus level, in order to confirm a linked operation with components existing in the related analog processing section 102.

Conventionally, however, existence of the analog processing section 102 makes it possible to evaluate a linked operation between the aforementioned analog processing section 102 and the digital circuit 11 only after the digital circuit 11 has actually been produced, and therefore an expense of remanufacturing the digital circuit 11, et cetera, has been large if a failure is discovered thereafter.

Accordingly, the present embodiment enables an evaluation of the digital circuit 11 at an apparatus level prior to actually producing the aforementioned digital circuit 11 by digitalizing the analog processing section 102 on a circuit evaluation apparatus 20 as described in the following.

As exemplified by FIG. 1, the circuit evaluation apparatus 20 according to the present embodiment includes a programmable logic circuit apparatus 20A and a control computer 26 for controlling it.

The programmable logic circuit apparatus 20A comprises one or a plurality of field-programmable gate arrays (FPGA) for example.

The programmable logic circuit apparatus 20A is installed with digital circuit part emulation logic 21-1 (i.e., the first emulation logic) and digital circuit part emulation logic 21-2, which are equipped respectively corresponding to the opposing telecommunication apparatuses A and B; an upper system part emulation logic 23-1 and upper system part emulation logic 23-2, and an analog section emulation logic 22 (i.e., the second emulation logic) for the digital processing of the analog processing section 102 which lies between the opposing telecommunication apparatuses A and B.

The analog section emulation logic 22 includes D/A conversion circuit part digital logic 22a, A/D conversion circuit part digital logic 22b, analog circuit part digital logic 22c and RF circuit part digital logic 22d for the purpose of digitalizing and emulating the respective functions of the above described D/A conversion circuit 12, A/D conversion circuit 13, analog circuit 14 and RF circuit 15, all of which belong to the telecommunication apparatus A side.

The analog section emulation logic 22 further includes D/A conversion circuit part digital logic 22e, A/D conversion circuit part digital logic 22f, analog circuit part digital logic 22g and RF circuit part digital logic 22h for the purpose of digitalizing and emulating the respective functions of the above described D/A conversion circuit 12, A/D conversion circuit 13, analog circuit 14 and RF circuit 15, all of which belong to the telecommunication apparatus B side.

In the case of a configuration example shown by FIG. 1, the transmission characteristic of the wireless propagation section 103 between the RF circuits 15 in the respective telecommunication apparatuses A and B is included in the RF circuit part digital logic 22d and RF circuit part digital logic 22h.

In this case, digital circuit part logic 21a respectively constituting the digital circuit part emulation logic 21-1 and digital circuit part emulation logic 21-2 can be implemented by writing to an FPGA comprising the programmable logic circuit apparatus 20A by using logic design data, almost as is, by a Hardware Description Language (i.e., a digital HDL) which is prepared for producing the above described digital circuit 11, as described later.

The upper system part emulation logic 23-1 and upper system part emulation logic 23-2 are implemented by writing the logic for emulating a digital control signal 16a which is exchanged between the upper level system 16 and digital circuit 11 to the programmable logic circuit apparatus 20A.

The analog section emulation logic 22 is structured by the Hardware Description Language so as to make the respective functions of the D/A conversion circuit part digital logic 22a through RF circuit part digital logic 22d of the telecommunication apparatus A side and of the D/A conversion circuit part digital logic 22e through RF circuit part digital logic 22h of the telecommunication apparatus B side, both digitally processible.

And the entire function of the analog section emulation logic 22 is implemented to be digitally processible by writing the emulation logic structured by the Hardware Description Language to the programmable logic circuit apparatus 20A.

That is, all of the above described digital signal 17a, analog signal 17b and high frequency signal 17c, which are shown by FIG. 3, are processed as a digital signal 17-1 internally to the analog section emulation logic 22.

The operations of the digital circuit part emulation logic 21-1, upper system part emulation logic 23-1, digital circuit part emulation logic 21-2, upper system part emulation logic 23-2 and analog section emulation logic 22 are controlled by the control computer 26.

That is, an instruction from the control computer 26 controls a start or stop of a telecommunication emulation between the telecommunication apparatuses A and B for the circuit evaluation apparatus 20. By this configuration, an operating state of the digital circuit 11 (i.e., the digital circuit part logic 21a) is evaluated in the same operating environment as the state (i.e., an apparatus level) of being mounted to the telecommunication apparatus 10.

And the emulation result of the digital circuit 11 (i.e., the digital circuit part logic 21a) is displayed by a display 26a of the control computer 26, or may be stored in a storage apparatus thereof (not shown herein).

As described above, the case of the circuit evaluation apparatus 20 according to the present embodiment implements the operations of the analog processing section 102 and wireless propagation section 103, which are related to the digital circuit 11 (i.e., the digital circuit part logic 21a), by the emulation logic which is installed in the programmable logic circuit apparatus 20A, thereby processing as a digital processing section 102a.

As described above, the telecommunication apparatus A replaces all of the digital circuit 11, which will be designed as an LSI, and the part, which is implemented in analog, from the interface of the digital circuit 11 to that of the digital circuit 11 of the opposite telecommunication apparatus B, by the analog section emulation logic 22 is installed in the programmable logic circuit apparatus 20A in the present embodiment.

An installation of the analog section emulation logic 22 by using an FPGA for example as the programmable logic circuit apparatus 20A enables an implementation of the same function, exclusively by a digital circuit, as the analog processing section 102 between the telecommunication apparatuses A and B earlier than an LSI production of the digital circuit 11.

The interface of the upper level system 16 side and that of the digital circuit 11 of the opposite telecommunication apparatus B are configured in the same manner as the actual telecommunication apparatus 10.

The following detailed description is of an example operation of the circuit evaluation method and circuit evaluation apparatus 20 according to the present embodiment by referring to the flow charts shown by FIGS. 4 and 5.

In the present embodiment, the development of the digital circuit 11 and that of the circuit evaluation apparatus 20 for evaluating the aforementioned digital circuit 11 progress in parallel.

On the development side of the circuit evaluation apparatus 20, the first task is to extract the transfer functions of the D/A conversion circuit 12 through RF circuit 15 in the analog processing section 102 and in the wireless propagation section 103 (step 201), and convert the transfer functions to expressions so as to be digitalized (step 202).

Next is to describe the expressions by the Hardware Description Language (step 203), perform a software simulation of the logic described by the Hardware Description Language (step 204) and examine it (step 205), followed by setting in the programmable logic circuit apparatus 20A of the circuit evaluation apparatus 20 as the analog section emulation logic 22 (step 206).

And the upper system part emulation logic 23-1 and upper system part emulation logic 23-2 are also installed in the circuit evaluation apparatus 20.

Parallel with the above described steps 201 through 206, in the development process of the digital circuit 11, the first task is to carry out a logical design and a physical design thereof (step 301), and build up digital circuit part logic 21a corresponding to the digital circuit 11 of the Hardware Description Language (step 302).

Next is to perform a software simulation for the obtained digital circuit part logic 21a (step 303) for confirming the operation of the digital circuit 11 as a unit (step 304).

Then the digital circuit part logic 21a is implemented in the FPGA of the circuit evaluation apparatus 20 as the digital circuit part emulation logic 21-1 and digital circuit part emulation logic 21-2 (step 207).

This makes the circuit evaluation apparatus 20 capable of evaluating the digital circuit 11.

Next is to evaluate the digital circuit 11 in the state of being mounted on the telecommunication apparatus 10 by an instruction from the control computer 26 making the circuit evaluation apparatus 20 operate (step 208).

That is, the actual operating states of the telecommunication apparatuses A and B are replayed by the circuit evaluation apparatus 20 and the operating state of the digital circuit 11 (i.e., the digital circuit part logic 21a) is evaluated by the control computer 26 as a result of the digital circuit part logic 21a corresponding to the digital circuit 11 of one telecommunication apparatus A side digitally operating together with the digital circuit part logic 21a corresponding to the digital circuit 11 of the telecommunication apparatus B on the opposite side by way of the analog section emulation logic 22 corresponding to the analog processing section 102 (step 208).

Then, the control computer 26 judges the quality of the evaluation result EV (step 209) and, if the evaluation result is bad, the current evaluation result EV is fed back to the above described step 301 for repeating the steps 301 through 304, thereby influencing the design process of the digital circuit 11.

If the evaluation result is judged as good, the production of the digital circuit 11 is carried out by photolithography for example by using the current digital circuit part logic 21a (step 401).

Then, the operation is evaluated by mounting the produced digital circuit 11 to a prototype model of the telecommunication apparatus 10 (step 402).

Then, the digital circuit 11 is shipped if the evaluation result is good (step 404).

If the evaluation result in the step 403 is bad, return to the above described step 301 to carrying out a redesign.

Here, the evaluation result of the case of the present embodiment, is reflected upon the design process of the step 301 by evaluating the digital circuit 11 in the same environment as that of mounting the digital circuit 11 on the actual telecommunication apparatus 10, that is, namely at an apparatus level, by mounting the digital circuit 11 (i.e., the digital circuit part logic 21a) on the circuit evaluation apparatus 20 which is capable of the processing of the analog processing section 102 as a digital processing section 102a by the analog section emulation logic 22 prior to producing the digital circuit 11 in the above described step 401.

This lowers a probability of the evaluation result being bad in the evaluation of the step 403 after producing the digital circuit 11, eliminates an occurrence of remanufacturing the digital circuit 11 and enables a production thereof at low cost and also with a short lead time.

FIG. 5 shows a development process of the digital circuit 11 according to the present embodiment as described above. Note that step numbers indicated in FIG. 5 correspond to the respective steps of the flow chart shown by FIG. 4.

Among the design process 501, production process 502 and product inspection process 503 for the digital circuit 11, an inspection of the aforementioned digital circuit 11 at the apparatus level has conventionally been performed in the product inspection process 503 by using a prototype model, et cetera, of the actual telecommunication apparatus 10.

Contrarily, the present embodiment enables an evaluation of the digital circuit 11 in the same environment as that of the state of being installed in the actual telecommunication apparatus 10 at an early stage by using the circuit evaluation apparatus 20 in the stage of design process 501 of the digital circuit 11, that is, prior to carrying out the production process 502.

Note that the circuit evaluation apparatus 20 exemplified by the above described FIG. 1 implements the digitalization of the wireless propagation section 103 by including in the logic function of the RF circuit part digital logic 22d and RF circuit part digital logic 22h as described above, an alternative configuration, however, may be so as to externally control a propagation characteristic, et cetera, of the high frequency signal 17c by digitalizing the part of the wireless propagation section 103 independently as described in the following.

That is, in the circuit evaluation apparatus 20 exemplified by FIG. 2, wireless propagation section emulation logic 24 (i.e., the third emulation logic) corresponding to the wireless propagation section 103 is equipped in apart of the analog section emulation logic 22.

The wireless propagation section emulation logic 24 comprises the function of emulating a propagation condition of the high frequency signal 17c in the wireless propagation section 103 by digital logic.

The propagation conditions of the high frequency signal 17c conceptually includes a variety of conditions such as an attenuation and fading thereof, a noise mixing, for example.

Meanwhile, the wireless propagation section emulation logic 24 is connected to the control computer 26 by way of a wireless propagation section characteristic setup circuit 25.

The wireless propagation section characteristic setup circuit 25 comprises the function of setting a parameter for making the wireless propagation section emulation logic 24 change the propagation conditions of the high frequency signal 17c.

And controlling the wireless propagation section characteristic setup circuit 25 by a command of the control computer 26 makes it possible to implement a discretionary propagation condition of the high frequency signal 17c in the wireless propagation section 103 by a digital emulation.

This configuration enables evaluation of the function of the digital circuit 11 under various usage conditions of the telecommunication apparatus 10 by changing the telecommunication conditions, in various ways, of the high frequency signal 17c between the telecommunication apparatuses A and B.

As described above, the present embodiment is configured to accomplish for example a part of the digital circuit 11 which is mounted to the telecommunication apparatus 10 by being designed as an LSI, and the same function as the analog processing section 102 from the interface of the digital circuit 11 to that of the digital circuit 11 of the telecommunication apparatus 10 on the opposite correspondent only by a digital circuit by using the programmable logic circuit apparatus 20A, such as an FPGA, which allows an implementation earlier than producing the digital circuit 11.

This configuration enables an evaluation of a digital circuit 11 in a state equivalent to the state of being mounted to the telecommunication apparatus 10 prior to shipping the digital circuit 11 (i.e., the LSI).

Accordingly, a capability of evaluating the digital circuit 11 in the state of being mounted to the telecommunication apparatus 10 prior to producing an LSI enables a validation of functionality of the digital circuit 11, which has conventionally been difficult to evaluate by a software evaluation.

And a failure which has conventionally been discovered in the evaluation process in the state of being mounted to the telecommunication apparatus 10 after shipping the digital circuit 11 (i.e., the LSI) can now be confirmed prior to the production, thereby providing an effect of reducing the number of the LSI to be remanufactured, i.e., the digital circuit 11.

This results in benefits such as reducing a production cost and shortening a development period of the digital circuit 11.

And the fact of digitalizing all of the analog processing section 102 relating to the digital circuit 11 by the analog section emulation logic 22 eliminates the limitation of an evaluation only at the actual operating speed as in the case of an analog processing section 102 existing, hence enabling a validation of the operation at low speed.

This results in enabling a validation of the operation of the digital circuit 11 in a state of lowering an operating clock of the analog section emulation logic 22 for example, eliminating a necessity of preparing a high performance, expensive circuit component, et cetera, for matching the frequency of the high frequency signal 17c for the circuit evaluation apparatus 20 and accordingly accomplishes a cost reduction therefor and in the evaluation process.

Note that it goes without saying that the present invention can be changed in various ways within the scope thereof, is not limited by the above-described exemplified embodiments.

The present invention is comprised to enable an evaluation of a digital circuit in a state of being mounted to a system apparatus prior to shipping the aforementioned digital circuit which is mounted to the aforementioned system apparatus including an analog part.

Also enabled is a validation of a function of a digital circuit which has conventionally been difficult to evaluate by a software simulation and an advanced validation of a failure which has conventionally been discovered in an apparatus as the subject of mounting after shipping the digital circuit product.

Also enabled is a reduction of development period and production cost of a digital circuit which is mounted to a system apparatus by including an analog part.

Also enabled is an evaluation, prior to shipping a digital circuit, in a state of the digital circuit being mounted to a system apparatus independent of an actual operating frequency of an analog part, for the digital circuit which is mounted to the aforementioned system apparatus including an analog part.

What is claimed is:

1. A circuit evaluation method for evaluating a digital circuit which is mounted to, and operated in, a system apparatus, comprising:
a first step for preparing first emulation logic which emulates an operation of the digital circuit;
a second step for preparing second emulation logic which emulates an operation of an analog section through which passes a signal input to, and output from, the digital circuit in a state of being mounted to the system apparatus; and
a third step for evaluating an operation of the digital circuit in a state of being mounted to the system apparatus by making the first and second emulation logic operate in a programmable logic circuit.

2. The circuit evaluation method according to claim 1, wherein
said system apparatus is a telecommunication apparatus for communicating with the system apparatus on an opposite side, and
said second emulation logic implements, in said programmable logic circuit, an operation of said analog section through which passes said signal exchanged between said digital circuits respectively mounted to each of a pair of the system apparatuses.

3. The circuit evaluation method according to claim 1, wherein
said analog section includes a wireless propagation section of said signal, said second emulation logic includes third emulation logic for emulating an operation of the wireless propagation section, and
said third step is for making a telecommunication state of the signal in the wireless propagation section implemented in said programmable logic circuit by the third emulation logic change in various ways by variably setting an operating parameter of the third emulation logic from the outside and for evaluating the digital circuit in a state of being mounted to said system apparatus.

4. The circuit evaluation method according to claim 1, wherein
said programmable logic circuit is a field-programmable gate array (FPGA).

5. The circuit evaluation method according to claim 1, wherein
said system apparatus is a wireless telecommunication apparatus and said digital circuit is a base band processing circuit.

6. A circuit evaluation apparatus for evaluating a digital circuit which is mounted to, and operated in, a system apparatus, comprising:
a programmable logic circuit for mounting first emulation logic which emulates an operation of the digital circuit and second emulation logic which emulates an operation of an analog section through which passes a signal input to, and output from, the digital circuit in a state of being mounted to the system apparatus; and
a control unit for emulating an operation of the digital circuit in a state of being mounted to the system apparatus by controlling the programmable logic circuit to make the first and second emulation logic operate.

7. The circuit evaluation apparatus according to claim 6, wherein
said system apparatus is a telecommunication apparatus for communicating with the system apparatus on an opposite side, and
said second emulation logic implements, in said programmable logic circuit, an operation of said analog section through which passes said signal exchanged between said digital circuits respectively mounted to each of a pair of the system apparatuses.

8. The circuit evaluation apparatus according to claim 6, wherein
said analog section includes a wireless propagation section of said signal, and
the circuit evaluation apparatus further comprises
third emulation logic for implementing an operation of the wireless propagation section in said programmable logic circuit, and
a wireless propagation section control unit for the purpose of making a telecommunication state of the signal in the wireless propagation section changed variously by variably setting an operating condition of the third emulation logic from the outside

9. The circuit evaluation apparatus according to claim 6, wherein
said programmable logic circuit comprises a field-programmable gate array (FPGA).

10. The circuit evaluation apparatus according to claim 6, wherein
said system apparatus is a wireless telecommunication apparatus and said digital circuit is a base band processing circuit.
